(19) United States
(12) Patent Application Publication
(10) Pub. No.: US 2016/0258803 A1
(43) Pub. Date: Sep. 8, 2016

(54) LIQUID MEASURING APPARATUS

(71) Applicant: FLOM Corporation, Ome City, Tokyo (JP)

(72) Inventors: Satoshi MOTOMIYA, Ome City, Tokyo (JP); Kazuji KOBAYASHI, Ome City, Tokyo (JP)

(73) Assignee: FLOM Corporation, Ome City, Tokyo (JP)

(21) Appl. No.: 14/414,764

(22) PCT Filed: Jun. 2, 2014
(86) PCT No.: PCT/JP2014/064639

§ 371 Date: Jan. 14, 2015

(51) Int. Cl. G01F 23/296

(52) U.S. Cl. CPC G01F 23/2967; G01F 23/2966

(57) ABSTRACT

A liquid measuring apparatus is designed for use in liquid chromatographic separation. The apparatus includes a plug body to be connected to the mouth or opening of the liquid container for opening/closing the liquid container, a sound wave producer disposed inside the plug body for providing output of sound wave directed toward the liquid, a receiver disposed inside the plug body for receiving a standing wave composed of an original sound wave provided by the sound wave producer and that part of the original sound wave which has hit against the surface of the liquid and has been reflected by the surface of the liquid, an algorithm for calculating the resonant frequency of the standing wave received by the receiver, and an algorithm for computing the amount of the liquid that remains in the liquid container.

### BACKGROUND

1. Field of the Invention

The present invention relates to a liquid measuring apparatus for measuring the amount of a liquid that remains to be available in liquid container.

2. Description of the Relevant Art

The liquid chromatography is the technology for separating a mixture sample as it is known to the prior art, in which a mobile phase (such as an eluant) is flowed into a stationary phase (such as a column) together with a chemical sample and the resulting mixture sample is separated by utilizing the differences in the rate or speed of the movement caused by the differences in the affinity with the stationary phase of each individual component contained in the mixture sample.

As one of the apparatus for analyzing a chemical sample by taking advantage of the liquid chromatographic separation, it is known to the prior art that there is an apparatus such as the one that has been proposed in the Patent Document 1 cited below is known to the prior art.

### Relevant Technical Documents

### Patent Documents

Patent Document 1: Japanese patent application No. H6 (1994)-347309 (unexamined)

Patent Document 2: Japanese patent application No. 2004-219113 (unexamined)

### SUMMARY

When the liquid chromatographic separation is used to analyze a particular mixture sample, it is often the case that it takes a long time to complete the analytic process. Even in the case where the automatic analytical process has been established, the conventional apparatus that is used for the analytical purpose has the construction that makes it difficult to keep track of the amount of a liquid such an eluant that remains to be available in the liquid container. The management required for keeping track of the amount of the eluant that remains to be available in the liquid container (such as the management required for the liquid refilling, replacing and other similar operations) is a complicated work. In order to eliminate such complicated work, there have been proposals or demands for any method that would make it easy to keep track of the amount of the eluant that remains to be available in the liquid container.

It is therefore an object of the present invention to provide a liquid measuring apparatus that can be used in the liquid chromatographic separation to measure the amount of a liquid such as an eluant that remains to be available in a liquid container and that makes it easy to keep track of the availability of the liquid in the liquid container by taking advantage of the standing sound wave.

In order to accomplish the above object, the present invention proposes to provide the liquid measuring apparatus as defined in the following claims.

The invention according to claim 1 provides a liquid measuring apparatus that is characterized by the fact that it comprises:

a plug body to be connected to the mouth or opening of said liquid container for opening/closing the mouth or opening of said liquid container;

a sound wave producing means disposed inside said plug body for providing output of sound waves directed toward said liquid;

a receiver means disposed inside said plug body for receiving a standing wave composed of an original sound wave provided by said sound wave producing means and that part of the original sound wave which has hit against the surface of said liquid and has been reflected by the surface of said liquid;

a detector means for detecting the signal transmitted from said receiver means; and

a liquid availability computing means for computing the amount of said liquid that remains to be available in said liquid container by taking advantage of the resonant frequency of the standing wave detected by said detector means.

The invention according to Claim 2 provides a liquid measuring apparatus as defined in Claim 1, the apparatus being characterized by the fact that said resonant frequencies are expressed by an integral multiple of a frequency having the ¼ wavelength which corresponds to the distance extending from the end of the surface of said liquid on the side on which said plug body is located to the surface of said liquid.

One of the advantages of the present invention resides in providing a liquid measuring apparatus that can be used in the liquid chromatographic separation to measure the amount of a liquid such as an eluant that remains to be available in a liquid container and that makes it easy to keep track of the availability of the liquid by taking advantage of the standing sound wave.

### BRIEF DESCRIPTION OF DRAWINGS

FIG. 1 represents one example of the constitutional arrangement of the liquid measuring apparatus in accordance with one embodiment of the present invention;

FIG. 2 is a graph diagram that represents the relationship between the amount of the liquid measured as remaining to be available at each respective temperature of water and methanol and the resonant frequency of the standing wave occurring inside the liquid container in accordance with the embodiment of the liquid measuring apparatus of the present invention;

FIG. 3 is a concept diagram that illustrates how a liquid such as an eluant can be measured by using the liquid measuring apparatus of the present invention in the liquid chromatographic separation although some parts or elements are omitted; and

FIG. 4 is a concept diagram that illustrates how the amount of the liquid such as the eluant that remains to be available can be measured from the state presented in the graph diagram of FIG. 2 although some parts or elements are omitted.

### BEST MODE OF EMBODYING THE INVENTION

One example of the liquid measuring apparatus in accordance with one embodiment of the present invention is now described by referring to the accompanying drawings.

### 1. Construction of the Present Invention

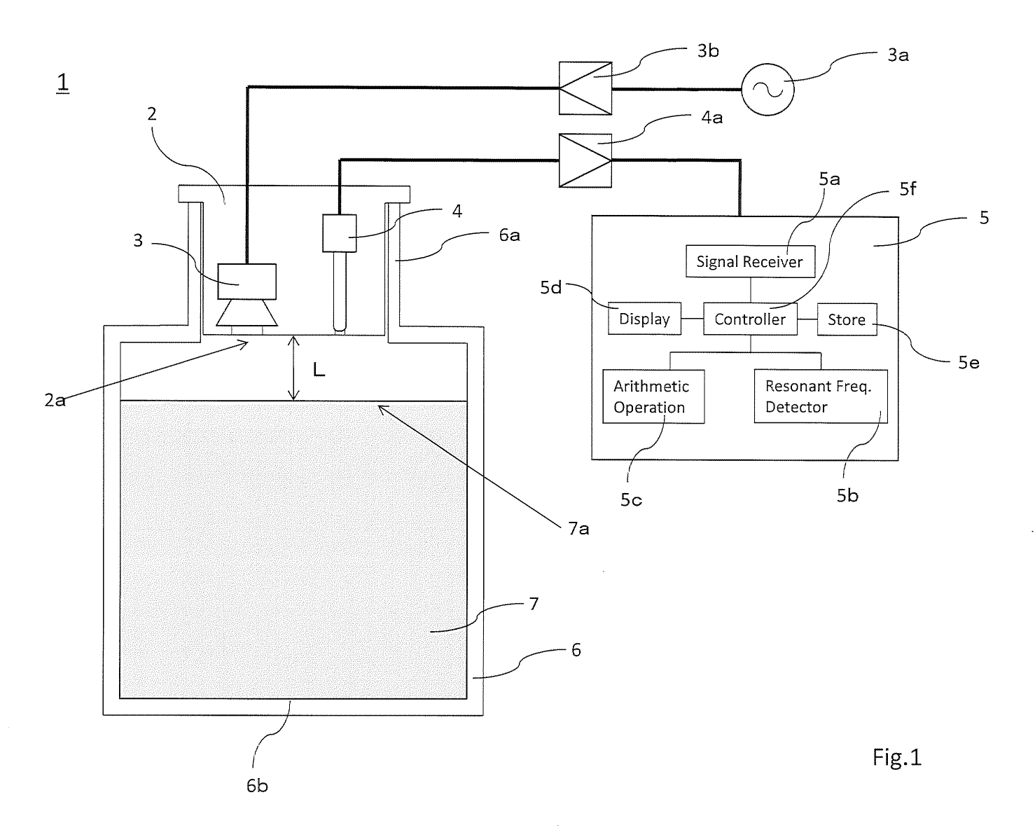

FIG. 1 is a diagram illustrating one example of the constitutional arrangement of the liquid measuring apparatus 1 in accordance with the embodiment of the present invention. In its specific form shown in FIG. 1, the liquid measuring apparatus 1 is the one that can be used to measure the amount of a liquid such as an eluant when a particular mixture sample is to be analyzed by using the liquid chromatographic separation.

The liquid measuring apparatus 1 includes a plug body 2 to be connected to a mouth (opening) 6a of a liquid container 6 in which a particular raw liquid (such as an eluant) 7 is contained. The plug body 2 may be made of any material such as resin, elastic member, metals and the like if it can close the mouth 6a securely.

Inside the plug body 2, there is a speaker 3 that acts as a sound wave producing means from which sound waves are provided and directed toward the raw liquid (eluant) 7. The sound waves are generated by the electrical signals provided by an electrical signal source 3a and having the appropriate frequencies amplified by an amplifier 3b.

Inside the plug body 2, there is also a microphone 4 that acts as a converter means for receiving a standing wave composed of an original sound wave provided by the sound wave producing means and that part of the original sound wave that has hit against the liquid surface 7a of the raw liquid (eluant) 7 and has been reflected from the liquid surface 7a and for converting the received standing sound waves into the corresponding electrical signal.

The liquid measuring apparatus 1 further includes an arithmetic operation unit 5 such as the one in a personal computer (PC). The arithmetic operation unit 5 includes a signal detecting means 5a that is enabled to receive the electrical signals that represent the standing waves converted by the microphone 4 and amplified by the amplifier 4a.

The arithmetic operation unit 5 further includes a resonant frequency calculating algorithm 5b that is enabled to convert the received electrical signals into the corresponding frequency data for the standing waves and to detect the resonant frequency that corresponds to the frequency at which the standing wave may be created.

The arithmetic operation unit 5 further includes a liquid availability computing algorithm 5c that is enabled to compute the amount of the raw liquid (eluant) 7 that remains to be available in the liquid container by using the resonant frequency as detected by the resonant frequency calculating algorithm 5b.

The arithmetic operation unit 5 further includes a display 5d such as an LC display on which the amount of the raw liquid (eluant) 7 that remains to be available as computed by the liquid availability computing portion 5c is presented and a storing algorithm 5e in which that availability of the liquid is stored.

In the storing algorithm 5e, the distance L extending from the end 2a of the liquid surface 7a on the side on which the plug body 2 is located to the liquid surface 7a and corresponding to the amount of the liquid (eluant) 7 that remains to be available has previously been stored.

Each of the functional algorithms mentioned above is operated under control of a controller program 5f that may be implemented by CPU, ROM and the like

In the form shown, the end 2a of the liquid surface 7a on the side on which the plug body 2 is located may be understood to correspond to the free end and the liquid surface 7a may be understood to correspond to the fixed end.

It follows from the above that the standing wave includes an anticode or loop that corresponds to the end 2a of the liquid surface 7a on the side on which the plug body 2 is located (mobile phase) and a node that corresponds to the liquid surface 7a (stationary phase). The resonant frequency of the standing wave can be expressed in terms of the following equation (Equation 1):

fₙ=(2n−1)v/4L

In the Equation 1,

fₙ: Resonant frequency of standing wave (Hz)

n: Positive integer

v: Speed or velocity of sound traveling across the space in the liquid container

L: Distance from liquid surface on the side on which the plug body is located to the liquid surface (m)

By using the Equation 1 mentioned above, the resonant frequency fₙ (Hz) of the standing wave that occurs when the liquid container having the capacity of one (L) is placed in the empty state will now be described. It should be noted that the phrase “the empty state” is assumed to mean that there is a little amount of the raw liquid (eluant) 7 remaining to be available on the bottom 6b of the liquid container 6.

If it is assumed that v=300 (m/s) and L=0.21 (m) in the Equation 1,then fₙ=357 (2n−1) results. From this, f₁=357 (Hz), f₂=1071 (Hz), f₃=1785 (Hz) and so on can be derived.

Next, if it is next assumed that v=300 (m/s) and L=0.13 (m) in the Equation 1, the resonant frequency of the standing wave fn (Hz) in the state in which 600 (mL) of the raw liquid (eluant) 7 remains to be available in the liquid container 6 having the capacity of one (L) will be fn=577 (2n−1). From this, f₁=577 (Hz), f₂=1731 (Hz), f₃=2885 (Hz) and so on can be derived.

The Equation 1 is the equation in which the distance L extending from the end 2a of the liquid surface 7a on the side on which the plug body 2 is located to the liquid surface 7a can be expressed in terms of the integral multiple (odd number multiple) of the ¼ wavelength of the standing wave or the equation in which the resonant frequency can be expressed in terms of the integral multiple (odd number multiple) of the frequency at which the distance L has a ¼ wavelength.

Since the resonant frequency f₃=1785 (Hz) of the standing wave that occurs when the liquid container 6 having the capacity of one (L) is placed in the empty state (that is, the frequency at which the distance L is assumed to have a ⅘ wavelength) is essentially approximate to the resonant frequency f₂=1731 (Hz) of the standing wave that occurs when 600 (mL) of the raw liquid (eluant) 7 remains in the liquid container 6 having the capacity of one (L) (that is, the frequency at which the distance L is assumed to have a ¾ wavelength), the Equation 1 can be used to compute the distance L in the liquid container 6 (for the container 6 having the capacity of one (L)) by adjusting the output of sound wave from the speaker 3 so that the resonant frequency f₂ of the standing wave (that is, the frequency at which the distance L is assumed to have a ¾ wavelength) be detected at all times.

Since there is a relationship between the distance L and the amount of the raw liquid (eluant) 7 that can be contained in the liquid container 6 (that is, the distance L will be 0.21 (m) when the container 6 is placed in the empty state), the amount of the raw liquid (eluant) 7 that remains to be available in the liquid container 6 will be able to be computed from the distance L thus computed.

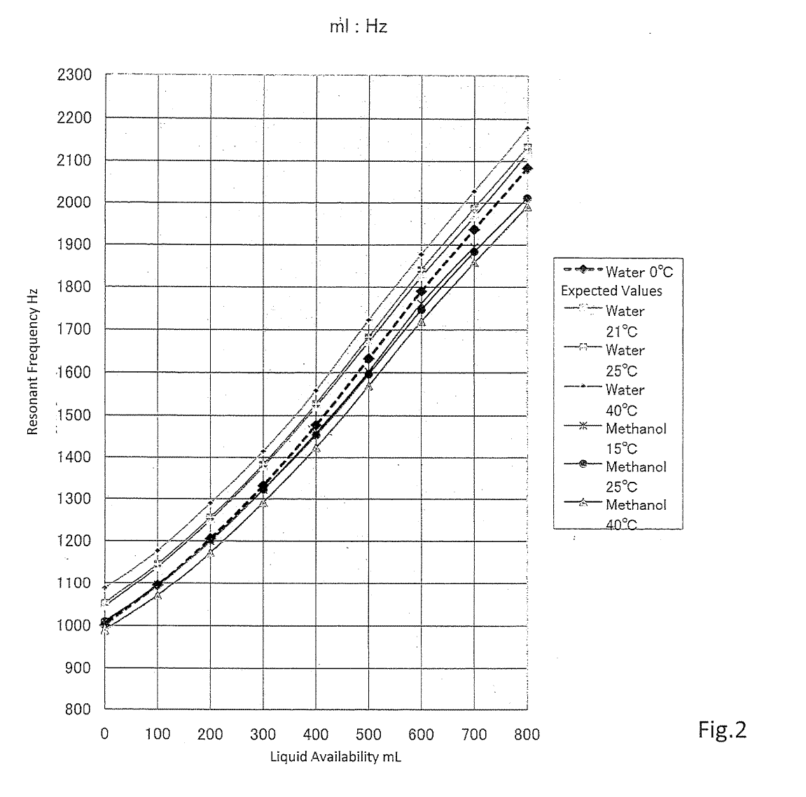

FIG. 2 is a graph diagram that represents the results that have been obtained by using the liquid measuring apparatus 1 of the present invention to measure the resonant frequency f₂ of the standing wave for the respective amounts of water and methanol that remain to be available in the liquid container 6 having the capacity of one (L). As it is noticed that the speed of sound wave may vary under the different temperatures, the graph in FIG. 9 has been obtained by changing the respective temperatures of water and methanol and then measuring the respective resonant frequencies f₂ of the standing waves under the temperatures thus changed.

The graph in FIG. 2 shows that the distance L will be about 0.13 (m) as computed by the Equation 1 if the resonant frequency f₂ is about 1700 (Hz), for example. From this, it can be determined that the amount of water or methanol that remains to be available will be equal to about 500 to 600 (mL). It can also be determined that the amount of water or methanol that remains to be available will be equal to the empty state if the resonant frequency f₂ is about 1000 to 1100 (Hz).

In the graph in FIG. 2, it is assumed that the lower limit of the amount of the liquid that remains to be available is defined as zero (mL), which means that this corresponds to “the empty state” as defined above. It is for the convenience of the description that this empty state is indicated as zero (mL). Even in the case where the liquid container 6 is placed in the empty state, only a little amount of the water or ethanol will still remain in the liquid container 6. This means that the resonant frequencies f₂ that occur in this empty state may be different for the different types of the liquid such as water and methanol.

The above case provides a suitable example in which the amount of the liquid that remains to be available in the container having the capacity of one (L) can be measured by detecting the resonant frequencies f₂ within the frequency band of between 800 and 2200 (Hz) whose output can be adjusted easily. By adjusting the output of sound wave from the speaker 3 so that the standing wave that occurs with the frequencies f₁, f₃ and so on can be received by the microphone 4, the amount of the liquid that remains to be available in the liquid container 6 can be measured by making it correspond to the capacity of the liquid container 6.

The liquid measuring apparatus 1 of the present invention having the construction described above can be used in the different analytical applications, and allows the amount of the liquid such as an aqueous solution or the like that remains to be available to be measured by utilizing the standing waves that occur with the appropriate resonant frequencies.

### 2. Measuring the Availability of Raw Liquid (Eluant)

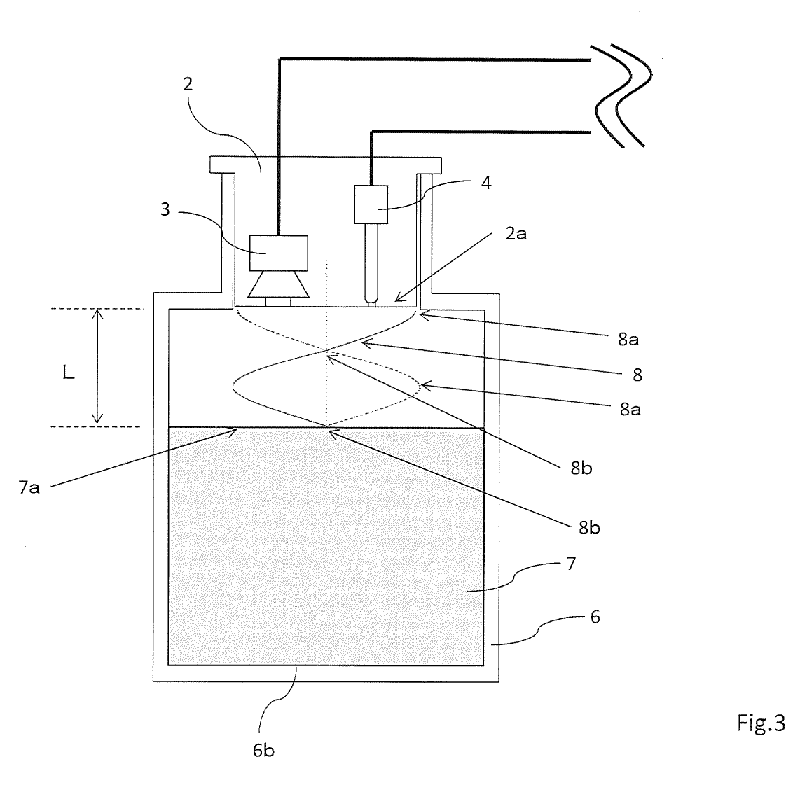

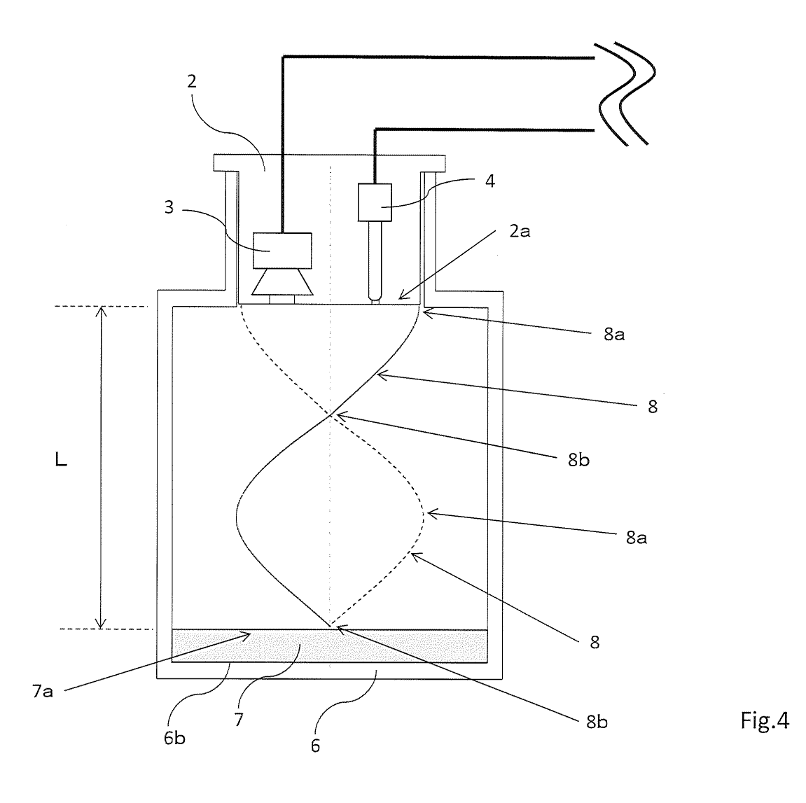

FIGS. 3 and 4 are concept diagrams that illustrate how the liquid such as eluant can be measured by using the liquid measuring apparatus 1 of the present invention in the liquid chromatographic separation. In the form shown, it is assumed that the liquid container 6 has the capacity of one (L) and that in the empty state, the distance L extending from the end 2a of the liquid surface 7a on the side on which the plug body 2 is located to the liquid surface 7a is 0.21 (m).

In FIG. 3, it is assumed that the output of sound wave from the speaker 3 can be adjusted by the signal source 3a and that the standing wave 8 can be produced between the end 2a of the liquid surface 7a on the side on which the plug body 2 is located to the liquid surface 7a. At this moment, the standing wave 8 has the waveform such that the distance L extending from the end 2a of the liquid surface 7a on the side on which the plug body 2 is located to the liquid surface 7a will have the ¾ wavelength. In this figure, reference numeral 8a denotes the antinode or loop of the standing wave 8, and 8b denotes the node of the standing wave 8.

The standing wave 8 is received by the microphone 4 which converts the received standing wave into the corresponding electrical signal to be transmitted to the arithmetic operation unit 5.

The arithmetic operation unit 5 includes a signal receiving means 5a for receiving the signal and a resonant frequency calculating algorithm 5b that has the functions of converting the electrical signal for the standing wave 8 received by the signal receiving means 5a into the corresponding frequency data and calculating the resonant frequency f₂ of the standing wave 8 from the converted frequency data.

As described above, the resonant frequency f₂ of the standing wave 8 has been calculated in order to enable the amount of the eluant 7 that remains to be available in the liquid container 6 to be measured easily when the resonant frequency f₂ resides within the frequency band of between 800 and 2200 (Hz).

In the state shown in FIG. 3, it is assumed that the speed or velocity v of sound wave traveling across the space in the liquid container 6 is equal to v=300 (m/s) and that if the resonant frequency f₂=1731 (Hz) of the standing wave 8 is detected by the resonant frequency calculating algorithm 5b, for example, a liquid availability computing algorithm 5c that is included in the arithmetic operation unit 5 will be enabled to use the Equation 1 to compute the distance L extending from the end 2a of the liquid surface 7a on the side on which the plug body 2 is located to the liquid surface 7a, that is, L=0.13 (m).

The arithmetic operation unit 5 further includes a storing algorithm 5e for storing the amount of the eluant 7 that remains to be available in the liquid container 6, and the liquid availability computing algorithm 5e has the functions of comparing the distance L that corresponds to that availability of the eluant 7 and extends from the end 2a of the liquid surface 7a on the side on which the plug body 2 is located to the liquid surface 7a against the distance L as computed by the liquid availability computing algorithm 5c and extracting the availability of the eluant 7 that is equal to 600 m(L) and corresponds to the appropriate distance L. The availability of the eluant 7 thus extracted will appear on the display 5d.

The graph in FIG. 4 shows that even in the case where the amount of the eluant 7 that remains to be available in the liquid container 6 is decreasing, the output of sound wave from the speaker 3 may be adjusted by the signal source 3a so that the standing wave 8 can be produced when the eluant 7 is placed between the end 2a of the liquid surface 7a on the side on which the plug body 2 is located and the liquid surface 7a.

The standing wave 8 is received and converted by the microphone 4 into the corresponding electrical signal to be transmitted to the arithmetic operation unit 5.

In response to the electrical signal, the arithmetic operation unit 5 will cause the resonant frequency calculating algorithm 5b to convert the electrical signal for the resonant wave 8 received by the signal receiving means 5a into the corresponding frequency data and calculate the resonant frequency f₂ of the standing wave 8 from the converted frequency data.

In the state shown in FIG. 4, it is assumed that the speed or velocity v of sound wave traveling across the space in the liquid container 6 is equal to v=300 (m/s) and that if the resonant frequency f₂=1071 (Hz) of the standing wave 8 is detected by the resonant frequency calculating algorithm 5b, for example, a liquid availability computing algorithm 5c that is included in the arithmetic operation unit 5 will be enabled to use the Equation 1 to compute the distance L extending from the end 2a of the liquid surface 7a on the side on which the plug body 2 is located to the liquid surface 7a, that is, L=0.21 (m).

The arithmetic operation unit 5 further includes a storing algorithm 5e in which the availability of the eluant 7 in the container 6 is stored, and the liquid availability computing algorithm 5e has the functions of comparing the distance L that corresponds to that availability of the eluant 7 and extends from the end 2a of the liquid surface 7a on the side on which the plug body 2 is located against the distance L as computed by the liquid availabilty computing algorithm 5c, and extracting the availability of the eluant 7 that corresponds to the appropriate distance L. The availability of the eluant 7 thus extracted will appear on the display 5d.

It may be understood from the foregoing description that the liquid measuring apparatus 1 of the present invention can be used in the liquid chromatographic separation to measure the amount of the liquid such as the eluant that remains to be available in the liquid container by taking advantage of the standing sound wave, thus making it possible to keep track of the availability of the eluant and making it easy to manage the availability of the liquid such as the eluant (such as the management required for the liquid refilling, replacing and other similar operations).

1. A liquid measuring apparatus for measuring the amount of a liquid that is available in a liquid container, the apparatus comprising:
a plug body to be connected to the mouth or opening of said liquid container for opening/closing the mouth or opening of said liquid container;
a sound wave producing means disposed inside said plug body for providing output of sound waves directed toward said liquid;
a receiver means disposed inside said plug body for receiving a standing wave composed of an original sound wave provided by said sound wave producing means and that part of the original sound wave which has hit against the surface of said liquid and has been reflected by the surface of said liquid;
a detector means for detecting the signal transmitted from said receiver means; and
a liquid availability computing means for computing the amount of said liquid that remains to be available in said liquid container by taking advantage of the resonant frequency of the standing wave detected by said detector means.

2. A liquid measuring apparatus as defined in claim 1, wherein said resonant frequency is expressed by an integral multiple of a frequency having the ¼ wavelength which corresponds to the distance extending from the end of the surface of said liquid on the side on which said plug body is located to the surface of said liquid.
